(19) United States
(12) Patent Application Publication
(10) Pub. No.: US 2026/0278083 A1
(43) Pub. Date: Sep. 17, 2026

(54) AUTOMATED ARTIFICIAL INTELLIGENCE SECURITY OPERATIONS CENTER INVESTIGATION AGENT

(71) Applicant: Microsoft Technology Licensing, LLC, Redmond, WA (US)

(72) Inventors: Maxim BRAITMAIERE, Kfar Yona (IL); Shachaf LEVY, Zikhron Ya'akov (IL); Aviel LAVIE, Tel Aviv (IL); Corina Eva FEUERSTEIN, Ramat HaSharon (IL); Hani Hana NEUVIRTH, Tel-Aviv (IL); Jael FAFNER, Tel Aviv (IL); lnbar ROTEM, Hod-Hasharon (IL); Tomer SOLOMON, Herzliya (IL); Eden ABADI, Yehud-Monosson (IL); Ryan Andrew MARCOTTE, Providence, RI (US); Etai Adiel AVIGAD, Ramat Gan (IL)

(73) Assignee: Microsoft Technology Licensing, LLC, Redmond, WA (US)

(21) Appl. No.: 19/082,155

(22) Filed: Mar. 17, 2025

(51) Int. Cl. G06F 21/55

(52) U.S. Cl. CPC G06F 21/554; G06F 2221/034

(57) ABSTRACT

A computing system for an automated artificial intelligence security operations center alert investigation includes processing circuitry configured to implement an automated artificial intelligence (AI) security operations center (SOC) investigation program. The AI SOC investigation program includes an automated SOC analyst (SA) investigation agent that receives a trigger to initiate an investigation for a security alert, retrieves alert evidence data including at least one entity related to the security alert, implements an investigation workflow to determine one or more entity investigation agents to investigate the entity, and implements the one or more entity investigation agents to investigate the entity. The SA investigation agent receives one or more respective intermediate verdicts from the one or more entity investigation agents, the one or more intermediate verdicts indicating whether the entity is malicious or benign, and determines a final verdict for the security alert based on the one or more intermediate verdicts.

### BACKGROUND

Many organizations utilize a security operations center (SOC) to monitor their information systems and data to detect and respond to security threats. SOC functions typically include the prevention, detection, identification, and investigation of security incidents, responding to identified threats, and recovery of system after a cybersecurity event. Conventionally structured as a collaboration between artificial intelligence (AI) agents and human analysts, engineers, and managers, an SOC can prevent and mitigate security incidents while minimizing the impact of such incidents on the productivity of the organization. Although the AI agents can efficiently process data and perform defined tasks, they are subject to hallucinations, and may generate incorrect conclusions for complex attack strategies or ambiguous findings. Due to the possibility of such errors, human review of AI agent outputs is often conducted to ensure the accuracy of the SOC, which can be time consuming, costly, and difficult to scale.

### SUMMARY

To address the issues discussed herein, computing systems and methods for an automated artificial intelligence security operations center alert investigation are provided. According to one aspect, a computing system includes processing circuitry configured to execute instructions using portions of associated memory to implement an automated artificial intelligence (AI) security operations center (SOC) investigation program. The automated AI SOC investigation program includes an automated SOC analyst (SA) investigation agent. In an inference phase, the SA investigation agent is configured to receive a trigger to initiate an investigation for a security alert and retrieve alert evidence data, including at least one entity related to the security alert. The SA investigation agent is further configured to implement an investigation workflow to determine one or more entity investigation agents to investigate the at least one entity included in the alert evidence data, and implement the determined one or more entity investigation agents to investigate the at least one entity. The SA investigation agent receives one or more respective intermediate verdicts from the one or more entity investigation agents, the one or more respective intermediate verdicts indicating whether the at least one entity is malicious or benign, and determines a final verdict for the security alert based on the one or more respective intermediate verdicts.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for an automated artificial intelligence security operations center alert investigation, according to one embodiment of the present disclosure.

FIG. 2 shows an inference flow with adaptability verdict confidence in accordance with the computing system of FIG. 1.

FIGS. 3A and 3B show a directed acyclic graph of an investigation workflow in accordance with the computing system of FIG. 1.

FIG. 4 shows an ingestion flow for a global whitelist for an adaptability agent in accordance with the computing system of FIG. 1.

FIG. 5 shows an ingestion flow for an entity-specific whitelist for entity adaptability tools in accordance with the computing system of FIG. 1.

FIG. 6 shows a flowchart of a method for investigating a security alert with an automated artificial intelligence security operations center, according to an example implementation of the present disclosure.

FIG. 7 shows a flowchart of a method for investigating a security alert with an adaptable automated artificial intelligence security operations center, according to an example implementation of the present disclosure.

FIG. 8 shows an example computing system according to one implementation of the present disclosure.

### DETAILED DESCRIPTION

In view of the issues discussed above, a computing system 10 for an automated artificial intelligence security operations center alert investigation is disclosed herein. The computing system 10 addresses the issues discussed above by executing an automated artificial intelligence (AI) security operations center (SOC) investigation program, including an SOC analyst (SA) investigation agent. The SA investigation agent implements an investigation workflow in which one or more entity investigation agents concurrently investigate entities included in alert evidence data. The system combines user-defined adaptability criteria with automated AI agents, thereby increasing the efficiency of SOC alert investigations while maintaining human guidance.

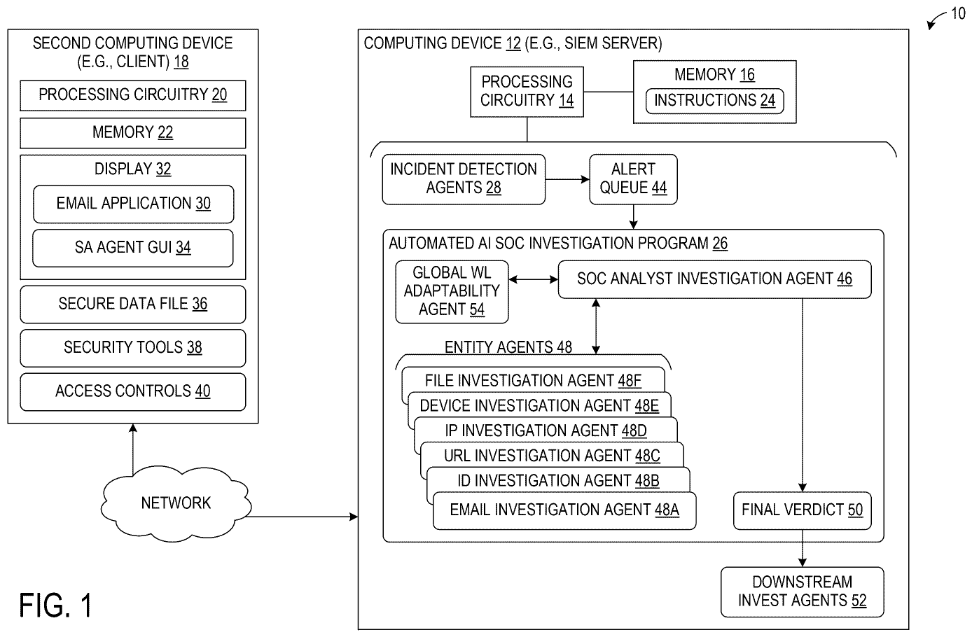

Referring initially to FIG. 1, the computing system 10 includes at least one computing device. The computing system 10 is illustrated as having a first computing device 12 including processing circuitry 14 and memory 16, and a second computing device 18 including processing circuitry 20 and memory 22, the second computing device 18 being in communication with the first computing device 12 via a network. In the embodiments described herein, the server 12 the handles detection and investigation phases of the overall SOC workflow, and may be implemented as security information and event management (SIEM) server, for example.

The illustrated implementation is exemplary in nature, and other configurations are possible. In the description below, the first computing device will be described as a server 12 and the second computing device will be described as a client computing device 18, and respective functions carried out at each device will be described. It will be appreciated that in other configurations, the computing system 10 may include a single computing device that carries out the salient functions of both the server 12 and client computing device 18, and that the first computing device could be a computing device other than server. In other alternative configurations, functions described as being carried out at the server 12 may alternatively be carried out at the client computing device 18 and vice versa.

Continuing with FIG. 1, the processing circuitry 14 is configured to execute instructions 24 using portions of associated memory 16 to implement an automated artificial intelligence (AI) security operations center (SOC) investigation program 26.

Upstream of the automated AI SOC investigation program 26, incident detection agents 28 analyze incoming data streams for potential security incidents, such as malware attacks and data breaches. Cybersecurity events may be detected via SIEM correlation rules, user and entity behavior analytics (UEBA), malware signatures, and attack patterns. As illustrated in FIG. 1, such events may be third party (3^{rd} P) incidents that occur at the client computing device 18 such as, for example, corrupt email attachments in an email application 30, which may be visible to a user via interfaces shown on a display 32 of the client computing device 18. As discussed in detail below, an SA investigation agent interface may be displayed on the display 32. The SA investigation agent interface may be implemented as an SA agent graphical user interface (GUI) 34 that is configured to receive user feedback about an investigation verdict.

Additionally or alternatively, the cybersecurity events may be first party (1^{st} P) security incidents, which can be sporadic or systematic. Sporadic security incidents are typically generated by human activity, such as sharing a secure data file 36 with unauthorized personnel. Systemic security incidents are more common than sporadic security incidents and may arise from, for example, misconfigured security tools 38 or weak access controls 40, such as lack of multi-factor authentication (MFA) or excessive user privileges.

The incident detection agents 28 generate security alerts for detected potential security incidents. It will be appreciated that the incident detection agents 28 may be embodied as human analysts, large language models (LLMs), or hybrid models that leverage the intuition and experience of human analysts with the rapid processing of LLMs. The security alerts are entered into an alert queue 44, with each security alert including alert evidence data and at least one entity related to the security alert.

A security alert may be retrieved from the alert queue 44 by an SOC analyst (SA) investigation agent 46 included in the automated AI SOC investigation program 26, thereby serving as a trigger for the SA investigation agent 46 to initiate an investigation for the security alert. The SA investigation agent 46 is configured to orchestrate the triage of the security alerts and determine if they are malicious or benign. Using machine learning (ML), LLMs, and predefined tools, the security alerts may be mapped to a comprehensive framework (e.g., ATT&CK) that defines tactics, techniques, and procedures (TTPs) used in cyberattacks and intrusions. Risk scores are assigned based on threat intelligence (TI) correlation, identification of same/similar indicators that were seen in past alert events, and detection of anomalous behavior. False positives (FP) are dismissed, and indeterminate and high-risk alerts, i.e., true positives (TP), are escalated for investigation by downstream investigation agents.

The SA investigation agent 46 may be implemented utilizing an LLM (e.g., the SA investigation agent can be a program that calls an LLM executed on a server and receives a response). The LLM can be a generative pre-trained transformer model, such as Chat-GPT 4o, LLaMA, etc. In some examples, the model can be a multi-modal model configured to accept text, images, and/or audio as forms of input and configured to generate text, images, and/or audio as output. It will be appreciated that the SA agent can be a small language model as well. Models such as Deepseek and o3 mini can also be used.

The SA investigation agent 46 is configured to retrieve the alert evidence data, including the at least one entity related to the security alert. As described herein, an entity is a digital object that may be or contain malicious content, such as an email, a user identity, a Uniform Resource Locator (URL), an Internet Protocol (IP) address, a device, and a file attachment, for example. It will be appreciated that the listed entities are merely exemplary, and that the computing system 10 may be applied to entities other than those described herein.

The SA investigation agent 46 serves as an investigation orchestrator and implements an investigation workflow to determine one or more entity investigation agents 48 to investigate the entities included in the alert evidence data, and implements the entity investigation agents 48 to investigate the entities. Similar to the entities discussed above, the entity investigation agents 48 described herein, including email investigation agent 48A, user identity investigation agent 48B, URL investigation agent 48C, IP investigation agent 48D, device investigation agent 48E, and file investigation agent 48F, are exemplary in nature and not intended to limit the scope of possible entity agents.

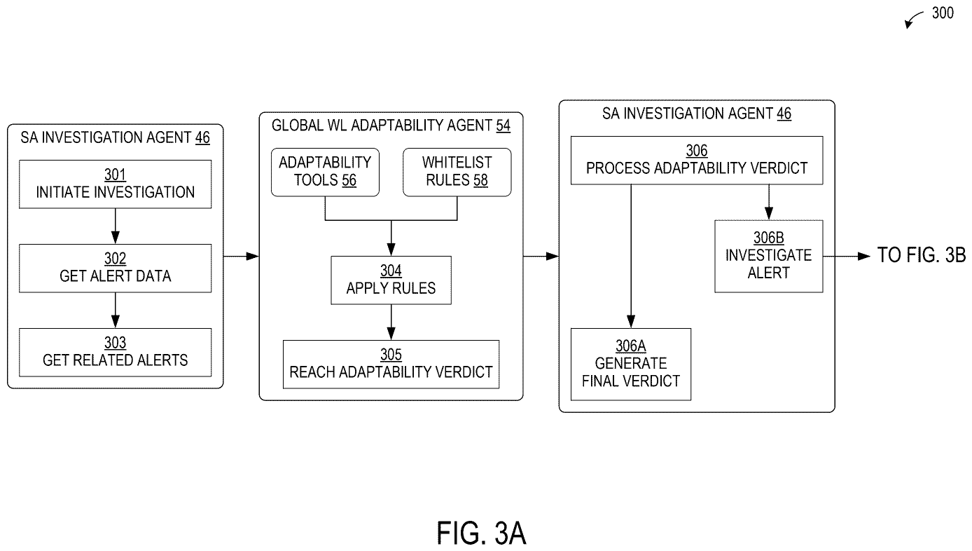

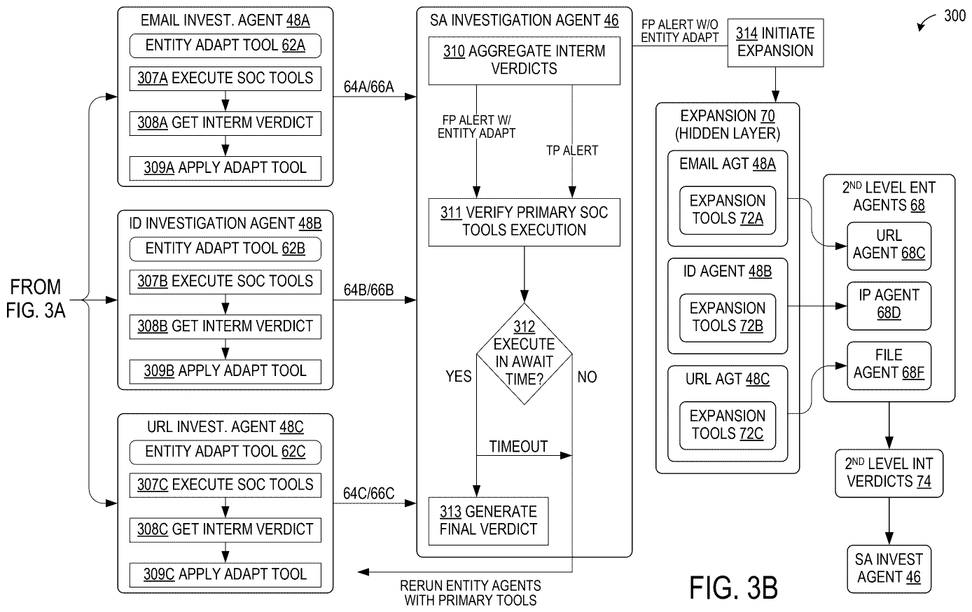

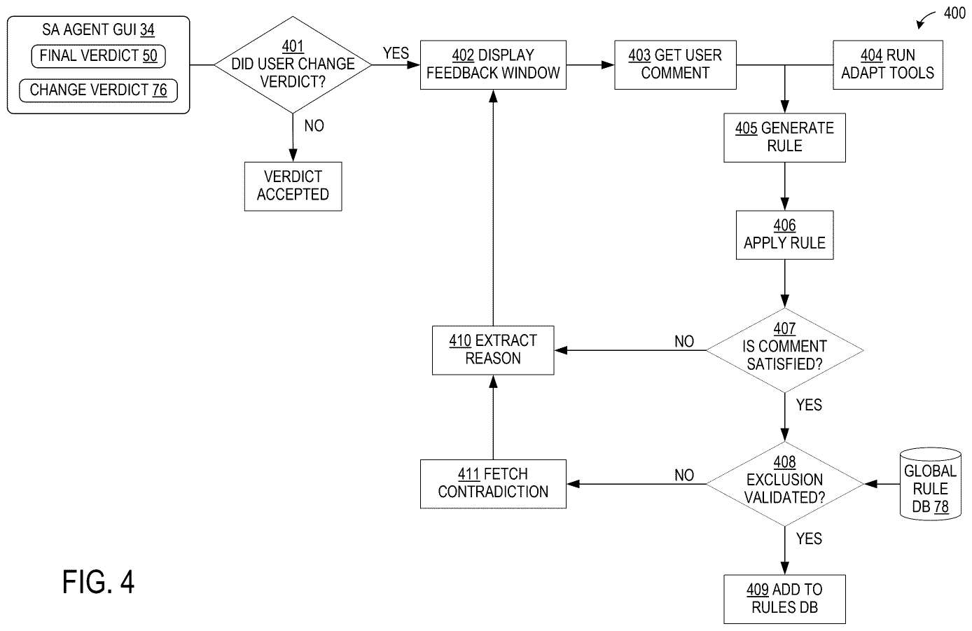

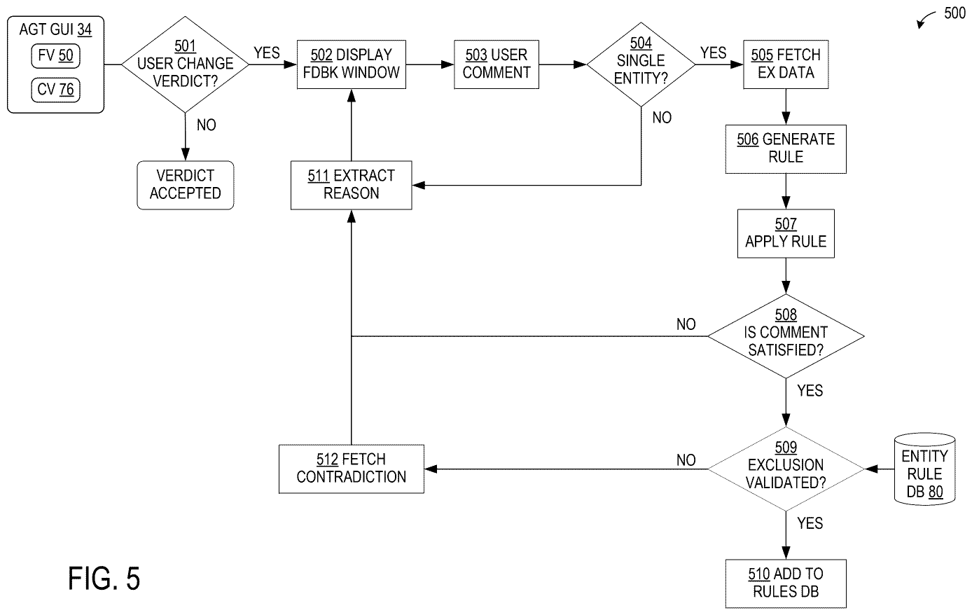

As described in detail below with reference to FIG. 3B, the SA investigation agent 46 receives one or more respective intermediate verdicts from the entity investigation agents 48, indicating whether the respective entity is malicious or benign. The intermediate verdicts are aggregated by the SA investigation agent 46, and a final verdict 50 is determined for the security alert based on the one or more respective intermediate verdicts. The final verdict 50 may be output by the SA investigation agent 46 and displayed in the SA agent interface 34 on the display 32 of the client computing device 18. As described below with reference to FIGS. 4 and 5, the user may provide feedback about the final verdict 50. If the final verdict 50 is verified or modified by the user to indicate the security alert is malicious, i.e., TP, or indeterminate, then it is output by the SA investigation agent 46 and received from the automated AI SOC investigation program 26 by downstream investigation agents 52, which are configured to conduct further investigation of the security alert and determine a root cause. It will be appreciated that a single malicious entity will trigger a TP verdict. If the verdict indicates the security alert is benign, i.e., FP, then the investigation is closed.

In some embodiments, the automated AI SOC investigation program 26 includes an adaptability agent 54, which may be configured as a global whitelist adaptability agent, as illustrated in FIG. 1 and described in detail below. In this scenario, the SA investigation analyst 46 receives a trigger to initiate an investigation for a security alert and retrieves a security alert from the queue 44 of security alerts. The SA investigation agent 46 may be further configured to retrieve a plurality of like security alerts, i.e., a plurality of security alerts involving a same entity type, such as suspicious IP addresses, from the queue of security alerts and implement a concurrent parallel investigation of each of the plurality of like security alerts. The SA investigation agent 46 then retrieves alert evidence data, which includes at least one entity related to the security alert, and implements the adaptability agent 54.

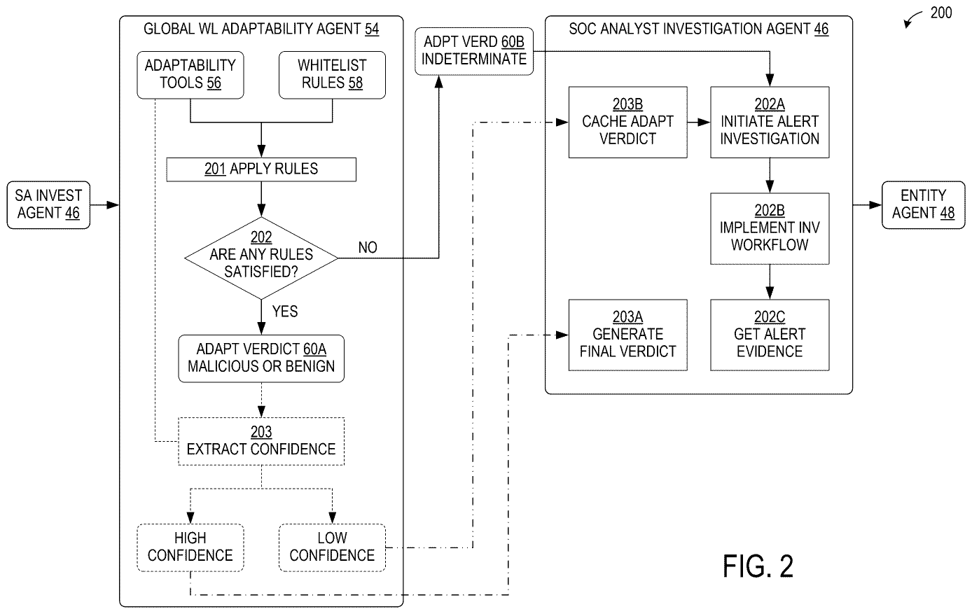

Turning to FIG. 2, an inference flow 200 with adaptability verdict confidence is shown, beginning with the implementation of the adaptability agent 54 by the SA investigation agent 46. While the SA investigation agent 46 serves as an investigation orchestrator, the adaptability agent 54 is configured to orchestrate an internal agentic flow to evaluate the security alert based on user-defined adaptability criteria. The adaptability agent 54 executes one or more adaptability tools 56 that process the alert evidence data according to the user-defined adaptability criteria to reach an adaptability verdict. The user-defined adaptability criteria includes a whitelist that specifies a plurality of whitelisted entities and/or whitelist rules 58. The whitelist is configured as a global whitelist, meaning that it is not entity-specific and can be applied to the alert evidence data as a whole. As such, the adaptability agent 54 is configured as a global whitelist adaptability agent, and is implemented utilizing an LLM. The whitelist rules 58 are a predefined set of data, e.g., sender, email subject, email content, that are defined in natural language and input to the adaptability agent 54. The adaptability agent 54 is configured to apply the whitelist rules 58 to perform a look-up of the entity related to the security alert on the whitelist, which is shown in FIG. 2 as step 201. At step 202, the adaptability agent 54 queries if any whitelist rules 58 are satisfied.

If the outcome is YES and performing the look-up determines a match, then the adaptability verdict 60A indicates the security alert is either malicious or benign. When the adaptability verdict 60A indicates that the security alert is malicious or benign, then the SA investigation agent 46 is configured to refrain from implementing an investigation workflow, and output a verdict that indicates the security alert is TP, requiring further investigation, or FP, and the alert can be closed. As such, the adaptability agent 54 enables a rapid determination of whether the security alert needs to be escalated or can be dismissed, without the need to initiate a triage investigation.

If the outcome to step 202 is NO and performing the look-up does not determine a match, then the adaptability verdict 60B indicates the security alert is indeterminate. When the adaptability verdict indicates the security alert is indeterminate, then the SA investigation agent 46 is configured to initiate an investigation for the security alert, as shown at step 202A in FIG. 2. The investigation then proceeds as described above with reference to FIG. 1. The SA investigation agent 46 implements the investigation workflow (step 202B), gets alert evidence (step 202C), and implements one or more entity investigation agents 48.

In some embodiments, the level of confidence for the adaptability verdict is scored, as indicated by the components in dashed line in FIG. 2. One of the adaptability tools 56 is configured to define a baseline confidence score for the adaptability verdict 60A. In such an implementation, the adaptability tool 56 extracts the confidence score from the adaptability verdict 60A, as shown at step 203, and compares it to the baseline confidence score. If a confidence score for the adaptability verdict is equal to or higher than a predetermined confidence threshold, thereby indicating a high confidence level, then the adaptability verdict 60A is confirmed. The SA investigation agent 46 then uses the adaptability verdict 60A to generate a final verdict 50, as shown by the dashed dot line leading to step 203A in FIG. 2.

If the confidence score for the adaptability verdict is lower than the predetermined confidence threshold, then the adaptability verdict 60A cannot be confirmed and is considered indeterminate. The SA investigation agent caches the adaptability verdict 60A for future reference, as indicated by the dashed dot dot line in FIG. 2, and initiates the alert investigation, as shown at steps 203B and 203C, respectively.

FIGS. 3A and 3B show a directed acyclic graph 300 of an investigation workflow. FIG. 3A generally summarizes the inference flow 200 shown in FIG. 2. Beginning at the SA investigation agent 46, the workflow comprises initiating the alert investigation at step 301, getting alert evidence data at step 302, and getting related alerts at step 303. Any prior alerts or cached adaptability verdicts involving similar alert evidence data and/or entities may be accessed by the SA investigation agent 46 to determine how the alert investigation was processed and what final verdict 50 was reached.

Continuing with the implementation of the whitelist adaptability agent 54, the adaptability agent 54 uses the adaptability tools 56 to apply the whitelist rules 58 to the alert evidence data, as shown at step 304. As discussed in detail above, the adaptability tools 56 process the alert evidence data according to the user-defined adaptability criteria to reach the adaptability verdict 60, indicated at step 305 in FIG. 3A.

The adaptability verdict 60 is relayed to the SA investigation agent 46, which processes the adaptability verdict 60 according to whether the alert evidence data was found to be malicious benign, or indeterminate, as shown at step 306. If the adaptability verdict 60A is determined to have a high level of confidence, the SA investigation agent 46 generates a final verdict 50, as shown at step 306A, indicating that the security alert is malicious or benign, and does not implement the investigation workflow. If the look-up of the entity related to the security alert does not satisfy any of the whitelist rules, or if the match has a low level of confidence, the SA investigation agent 46 initiates the alert investigation, as shown at step 306B.

Continuing with FIG. 3B, the SA investigation agent 46 implements one or more entity investigation agents 48 to investigate an entity included in the alert evidence data. In the example illustrated in FIG. 3B, three entity investigation agents 48, email investigation agent 48A, user identity investigation agent 48B, and URL investigation agent 48C, are implemented by the SA investigation agent 46. It will be appreciated that the illustrated entity investigation agents 48 are merely examples of any number of suitable entity investigation agents that may be implemented to investigate entities in the alert evidence data, and are not intended to limit the scope of the disclosure.

Each entity investigation agent 48 is configured to orchestrate an internal agentic flow to investigate a specified type of entity included in the alert evidence data. As shown in FIG. 3B at steps 307A, 307B, and 307C, the entity investigation agents 48 execute one or more SOC tools to investigate the respective entity-specific alert evidence data and reach an intermediate verdict. The SOC tools may include one or more primary tools, independent tools, and 3^{rd} P tools. Each of the entity investigation agents 48 additionally includes at least one entity-specific adaptability tool 62 configured to process the intermediate verdict according to the user-defined adaptability criteria to determine whether the entity isas malicious or benign. As discussed in detail below with reference to FIG. 5, the entity-specific adaptability tool 62 can be configured as an entity-specific whitelist with rules that apply to a relevant entity. This is in contrast to the global whitelist rules that can refer to more than one entity and can result in a preemptive termination of a security alert investigation, as discussed herein with reference to FIGS. 2 and 4.

The email investigation agent 48A may execute SOC tools that analyze email headers, attachments, links, phishing attempts, and digital reputation of the sender. These tools may include, but are not limited to, email security and threat protection, Security Information and Event Management (SIEM), Threat Intelligence (TI), phishing and fraud detection, authentication and spoofing protection, digital forensics, fraud monitoring, and dark web monitoring, for example.

The user identity investigation agent 48B may execute SOC tools that track authentication, access logs, behavioral patterns, links to security threats and/or breaches, and inconsistencies. These tools may include, but are not limited to, SIEM, TI, Identity and Access Management (IAM), User Behavior Analytics (UBA), Endpoint Detection and Response (EDR), Cloud Access Security Broker (CASB), digital forensics, fraud monitoring, and dark web monitoring, for example.

The URL investigation agent 48C may execute SOC tools that analyze domains, check for malware, detect phishing schemes, and identify suspect web traffic. These tools may include, but are not limited to, SIEM, TI, phishing and fraud detection, URL reputation analysis, web traffic and network monitoring, sandbox and malware analysis for URLs, Domain Name System (DNS) and domain investigation, and dark web monitoring, for example.

After executing the SOC tools to investigate the respective entity-specific alert evidence data, the entity investigation agents 48 are configured to reach a respective intermediate verdict 64A, 64B, 64C, as indicated at steps 308A, 308B, and 308C in FIG. 3B. Similar to the whitelist adaptability agent 54 discussed above with reference to FIG. 2, the entity-specific adaptability tools 62A, 62B, 62C are configured to process the respective intermediate verdict 64A, 64B, 64C according to the entity-specific whitelist included in the user-defined adaptability criteria, as shown at steps 309A, 309B, 309C of FIG. 3B. Applying the entity-specific adaptability tools 62A, 62B, 62C produces the respective adapted intermediate verdicts 66A, 66B, 66C.

As discussed above with reference to FIG. 1, the SA investigation agent 46 is configured to receive the respective adaptive intermediate verdict 66 from each entity investigation agent 48, indicating whether the respective entity is malicious or benign. It will be appreciated that, in some implementations, the entity investigation agent 48 may not be provided with an entity-specific adaption tool 62. In such cases, the SA investigation agent 46 receives the intermediate verdict 64, as indicated in FIG. 3B.

Upon receiving the respective adaptive intermediate verdicts 66A, 66B, 66C, the SA investigation agent 46 aggregates the adapted intermediate verdicts 66A, 66B, 66C at step 310. When the intermediate verdict is FP and was processed with entity adaptability tools 62 or when the intermediate verdict is TP, the SA investigation agent 46 is configured to verify that each of the entity investigation agents 48A, 48B, 48C executed the primary SOC tools during their respective entity investigations, as shown at step 311. The primary SOC tools are mandatory tools that must be executed in order to provide the final verdict 50.

At step 312, the SA investigation agent 46 may query if the if the entity investigation agents 48 completed execution of the primary SOC tools within a predetermined await time. If the outcome is YES, the SA investigation agent 46 may generate a final verdict 50, as shown at step 313 in FIG. 3B. As discussed below, the final verdict 50 may be displayed in the SA investigation agent interface 34 on the client computing device 18, and the user may agree or disagree with the final verdict 50.

If the outcome is NO and one or more entity investigation agents 48 has not completed execution of the primary tools within a predetermined await time, the SA investigation agent is configured to rerun the one or more entity investigation agents 48 with the primary tools such that a final verdict 50 may be met.

When the intermediate verdict is FP and was not processed with an entity-specific adaptability tool 62, the SA investigation agent 46 is not configured to generate a final verdict 50, and the investigation may expand to other entities that are related to entity that was investigated with the entity investigation agent 48. For example, if the entity is an email that was not investigated with entity adaptability tools, then one or more additional entities in the email can be further investigated. In this embodiment, the one or more entity investigation agents 48 are first-level entity investigation agents and the at least one entity is a first-level entity, and the SA investigation agent 48 instructs the first-level agents 48 to implement one or more second-level entity investigation agents 68 to investigate at least one second-level entity related to the first-level entity.

As shown at step 314, the SA investigation agent 46 is configured to initiate an expansion and sends the alert evidence data of the FP that was processed without entity adaptability tools to the first-level entity investigation agents 48 in the expansion layer 70, which may be implemented as a hidden layer. The first-level entity investigation agents 48 are equipped with respective expansion tools 72A, 72B, 72C that are executed to call the second-level entity investigation agents, illustrated in FIG. 3B as the URL investigation agent 68C, IP investigation agent 68D, and file investigation agent 68F. Upon implementation, the second-level entity investigation agents 68C, 68D, 68F are configured to investigate the one or more second-level entities similarly to the investigation of the first-level entities to reach respective second-level intermediate verdicts 74. The one or more second-level intermediate verdicts 74 are output to the SA investigation agent 46, which aggregates the second-level intermediate verdicts 74 when there are more than one, and continues to process the alert investigation as described in detail above.

FIG. 4 shows an ingestion flow 400 for a global whitelist for an adaptability agent 54. The ingestion flow 400 enables new classification rules in accordance with user feedback to be incorporated into the existing rules that are applied at an incident level, i.e., they may apply to more than one entity. As discussed above with reference to FIG. 1, the client computing device 18 includes an SA agent GUI 34 that is configured to receive user feedback regarding a final verdict 50. Upon displaying the final verdict 50, the SA agent GUI 34 may provide a tool that permits the user to change the final verdict 50. The tool may be embodied as a selectable button 76, or another suitable selectable mechanism. At step 401 of the ingestion flow 400, the SA investigation agent 34 queries if the user changed the final verdict. If the outcome is NO, then the final verdict is determined to be accepted. If the outcome is YES, then the ingestion flow 400 proceeds to step 402, in which a feedback window is displayed in the SA agent GUI 34. At step 403, the ingestion flow 400 may receive a user comment regarding why the final verdict 50 was changed. The user's comment is rephrased into a classification rule and run against existing global adaptability tools at step 404. If the classification rule is not included in the existing global adaptability tools, a new global whitelist rule is generated and applied to the alert evidence data at steps 405 and 406, respectively. At step 407, the ingestion flow 400 is configured to query if the user's comment was satisfied. If the outcome is YES, the ingestion flow 400 proceeds to step 408 in which the ingestion flow 400 queries if the new global whitelist rule can be validated for mutual exclusion, indicating that it does not contradict any existing global whitelist rules stored in a global whitelist rule database 78. If the outcome is YES, the new global whitelist rule is added to the global whitelist rule database 78 at step 409. Returning to step 407, if it is determined that the new global whitelist rule does not satisfy the user's comment, the outcome is NO, and a reason for the outcome is extracted at step 410 and displayed to the user in the feedback window. Returning to step 408, if the new global whitelist rule contradicts any existing global whitelist rules, the outcome is NO, and the ingestion flow 400 fetches the contradiction at step 411, extracts a reason for the contraction at step 410, and displays a reason for the outcome in the feedback window.

FIG. 5 shows an ingestion flow 500 for an entity-specific whitelist for entity adaptability tools in an entity investigation agent. The ingestion flow 500 enables new classification rules in accordance with user feedback to be incorporated into the existing rules that are applied at an entity investigation agent level. The ingestion flow 500 is generally similar to the ingestion flow 400, with the additional query of whether the user comment applies to a single entity. At step 501, the SA investigation agent 34 queries if the user changed the final verdict. If the outcome is NO, then the final verdict is determined to be accepted. If the outcome is YES, then the ingestion flow 500 proceeds to step 502 and displays a feedback window in the SA agent GUI 34. At step 503, the ingestion flow 500 may receive a user comment regarding why the final verdict 50 was changed. The user's comment is rephrased into an entity classification rule and queried at step 504 to determine if the comment applies to a single entity. If the outcome is YES, the ingestion flow 500 proceeds to step 505, and data from the execution of the relevant entity investigation agent is fetched such that the user's comment can be compared to existing entity adaptability tools. If the classification rule is not included in the existing entity adaptability tools, a new entity whitelist rule is generated and applied to the alert evidence data at steps 506 and 507, respectively. At step 508, the ingestion flow 500 is configured to query if the user's comment was satisfied. If the outcome is YES, the flow proceeds to step 509 in which the ingestion flow 500 queries if the new entity whitelist rule can be validated for mutual exclusion, indicating that it does not contradict any existing rules stored in an entity whitelist rule database 80. If the outcome is YES, the new global whitelist rule is added to the entity whitelist rule database 80 at step 510. Returning to step 504, if it is determined that the entity classification rule applies to more than one entity, the outcome is NO, and a reason for the outcome is extracted at step 511 and displayed to the user in the feedback window. Returning to step 508, if it is determined that the new entity whitelist rule does not satisfy the user's comment, the outcome is NO, and a reason for the outcome is extracted at step 511 and displayed to the user in the feedback window. Returning to step 509, if the new entity whitelist rule contradicts any existing entity whitelist rules, the outcome is NO, and the ingestion flow 500 fetches the contradiction at step 512, extracts a reason for the contraction at step 511, and displays a reason for the outcome in the feedback window.

The SA investigation agent 46 described herein enables adaptable automated investigations of security alerts, based on user-defined guidelines and rules. Providing the opportunity for the user to accept or modify a verdict ensures that the agents described herein continue to improve their respective agentic flows based on the user's feedback and adjustments. Verdicts are output with an execution path and reasoning, thereby allowing a user to monitor the quality of the output and correct any hallucinations or erroneous conclusions. Each entity investigation agent is provided with a baseline behavior according to the onboard primary tools, but has an extensible architecture that can be customized by integrating third party tools. As such, the disclosed computing system provides rapid, versatile, and accurate triage of potential cybersecurity threats with the benefit of human oversight.

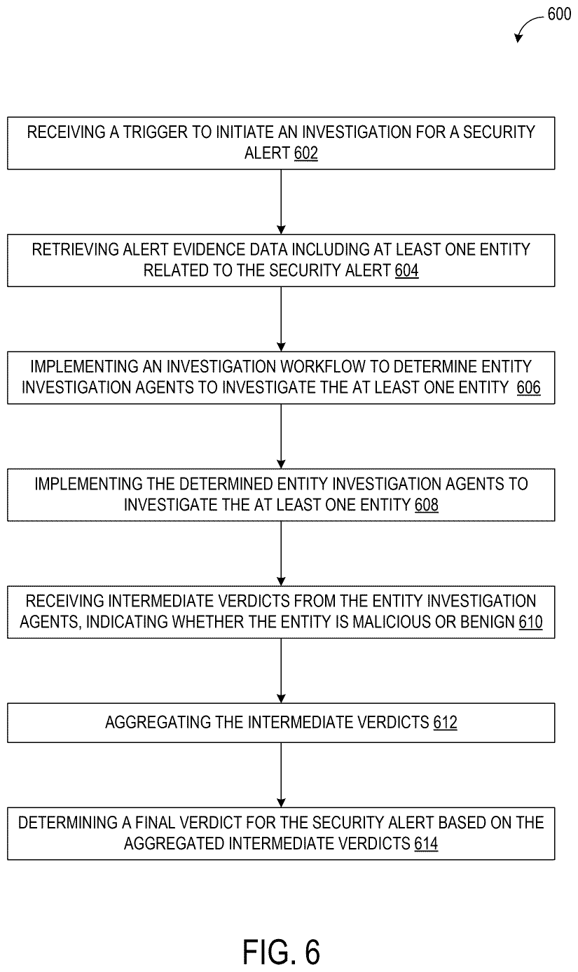

FIG. 6 shows a flowchart of a method 600 for investigating a security alert with an automated artificial intelligence security operations center. Method 600 may be implemented by the hardware and software of computing system 10 described above, such as the SA investigation agent 46, or by other suitable hardware and software. At step 602, the method 600 may include receiving a trigger to initiate an investigation for a security alert. As described above, the security alert may be retrieved from the alert queue by the SA investigation agent, thereby serving as a trigger to initiate the investigation. In some embodiments, the SA investigation agent may retrieve a plurality of like security alerts from the queue of security alerts, and implement a concurrent parallel investigation of each of the plurality of like security alerts.

Proceeding from step 602 to step 604, at step 604 the method 600 may further include retrieving alert evidence data. As described in detail above, the alert evidence data includes at least one entity related to the security alert.

Advancing from step 604 to step 606, at step 606 the method 600 may further include implementing an investigation workflow to determine one or more entity investigation agents to investigate the at least one entity included in the alert evidence data.

Continuing from step 606 to step 608, at step 608 the method 600 may further include implementing the determined one or more entity investigation agents to investigate the at least one entity. As described above, the one or more entity investigation agents may execute one or more primary tools, independent tools, and third party tools to investigate the at least one entity, and the SA investigation agent may verify that each of the one or more entity investigation agents executed the primary tools during their respective investigations. When one or more entity investigation agents do not complete execution of the primary tools within a predetermined await time, the SA investigation agent may rerun the one or more entity investigation agents with the primary tools.

Proceeding from step 608 to step 610, at step 610 the method 600 may further include receiving one or more respective intermediate verdicts from the one or more entity investigation agents. As discussed herein, the one or more respective intermediate verdicts indicate whether the at least one entity is malicious or benign.

Advancing from step 610 to step 612, at step 612, when there are a plurality of intermediate verdicts, the method 600 may further include aggregating the intermediate verdicts.

Continuing from step 612 to step 614, at step 614 the method 600 may further include determining a final verdict for the security alert based on the one or more respective intermediate verdicts.

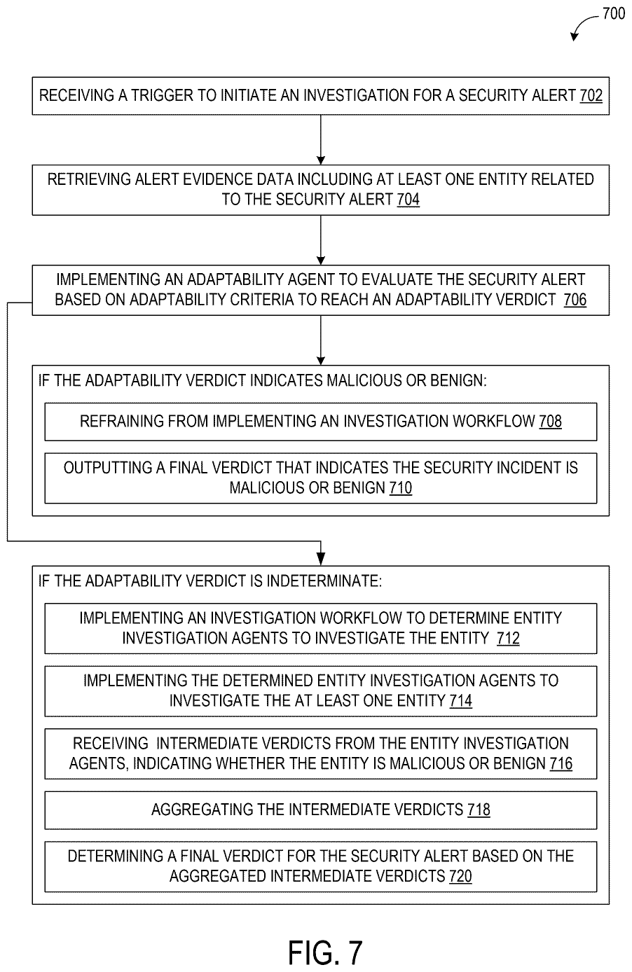

FIG. 7 shows a flowchart of a method 700 for investigating a security alert with an adaptable automated artificial intelligence security operations center. Method 700 may be implemented by the hardware and software of computing system 10 described above, such as the SA investigation agent 46, or by other suitable hardware and software. At step 702, the method 700 may include receiving a trigger to initiate an investigation for a security alert.

Proceeding from step 702 to step 704, at step 704 the method 700 may further include retrieving alert evidence data. As described in detail above, the alert evidence data includes at least one entity related to the security alert.

Advancing from step 704 to step 706, at step 706 the method 700 may further include implementing an adaptability agent to evaluate the security alert based on user-defined adaptability criteria. As discussed herein, the adaptability agent includes an adaptability tool that is configured to process the alert evidence data according to user-defined adaptability criteria to reach an adaptability verdict.

If the adaptability verdict indicates the security alert is malicious or benign, then the method includes steps 708 and 710. Continuing from step 706 to step 708, at step 708 the method 700 may further include refraining from implementing an investigation workflow.

Proceeding from step 708 to step 710, at step 710 the method 700 may further include outputting a final verdict that indicates the security alert is malicious or benign.

If the adaptability verdict is indeterminate, then the method includes steps 712 to 720. Advancing from step 706 to step 712, at step 712 the method 700 may further include implementing an investigation workflow to determine one or more entity investigation agents to investigate the at least one entity included in the alert evidence data.

Continuing from step 712 to step 714, at step 714 the method 700 may further include implementing the determined one or more entity investigation agents to investigate the at least one entity. As described above, the one or more entity investigation agents may execute one or more primary tools, independent tools, and third party tools to investigate the at least one entity, and the SA investigation agent may verify that each of the one or more entity investigation agents executed the primary tools during their respective investigations. When one or more entity investigation agents do not complete execution of the primary tools within a predetermined await time, the SA investigation agent may rerun the one or more entity investigation agents with the primary tools.

Proceeding from step 714 to step 716, at step 716 the method 700 may further include receiving one or more respective intermediate verdicts from the one or more entity investigation agents. As discussed herein, the one or more respective intermediate verdicts indicate whether the at least one entity is malicious or benign.

Advancing from step 716 to step 718, at step 718, when there are a plurality of intermediate verdicts, the method 700 may further include aggregating the intermediate verdicts.

Continuing from step 718 to step 720, at step 720 the method 600 may further include determining a final verdict for the security alert based on the one or more respective intermediate verdicts.

In some embodiments, the methods and processes described herein may be tied to a computing system of one or more computing devices. In particular, such methods and processes may be implemented as a computer-application program or service, an application-programming interface (API), a library, and/or other computer-program product.

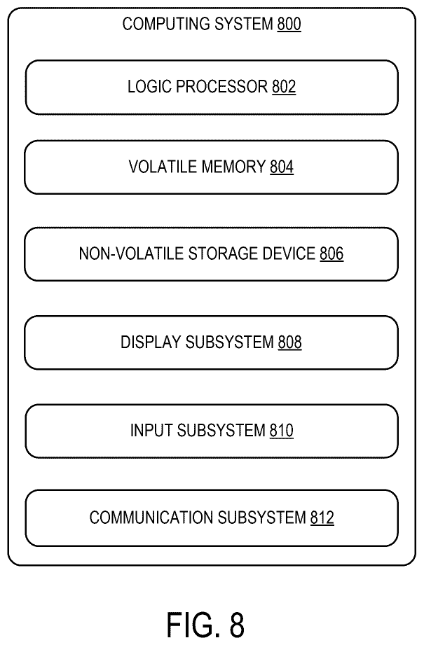

FIG. 8 schematically shows a non-limiting embodiment of a computing system 800 that can enact one or more of the methods and processes described above. Computing system 800 is shown in simplified form. Computing system 800 may embody the computing system 10 described above and illustrated in FIG. 1. Components of computing system 800 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 800 includes a logic processor 802 volatile memory 804, and a non-volatile storage device 806. Computing system 800 may optionally include a display subsystem 808, input subsystem 810, communication subsystem 812, and/or other components not shown in FIG. 8.

Logic processor 802 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 802 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 806 includes one or more physical devices configured to hold instructions executable by the logic processors to implement the methods and processes described herein. When such methods and processes are implemented, the state of non-volatile storage device 806 may be transformed—e.g., to hold different data.

Non-volatile storage device 806 may include physical devices that are removable and/or built in. Non-volatile storage device 806 may include optical memory, semiconductor memory, and/or magnetic memory, or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by logic processor 802 to temporarily store information during processing of software instructions. It will be appreciated that volatile memory 804 typically does not continue to store instructions when power is cut to the volatile memory 804.

Aspects of logic processor 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 typically implemented in software by a processor to perform a particular function using portions of volatile memory, which function involves transformative processing that specially configures the processor to perform the function. Thus, a module, program, or engine may be instantiated via logic processor 802 executing instructions held by non-volatile storage device 806, using portions of volatile memory 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 808 may be used to present a visual representation of data held by non-volatile storage device 806. The visual representation may take the form of a graphical user interface (GUI). As the herein described methods and processes change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with logic processor 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, camera, or microphone.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 800 to send and/or receive messages to and/or from other devices via a network such as the Internet.

The following paragraphs provide additional support for the claims of the subject application. One aspect provides a computing system for an automated artificial intelligence security operations center alert investigation. The computing system for the automated artificial intelligence security operations center alert investigation may comprise a computing device including processing circuitry configured to execute instructions using portions of associated memory to implement an automated artificial intelligence (AI) security operations center (SOC) investigation program. The automated AI SOC investigation program may include an SOC analyst (SA) investigation agent. The SA investigation agent may be configured to, in an inference phase, receive a trigger to initiate an investigation for a security alert and retrieve alert evidence data. The alert evidence data may include at least one entity related to the security alert. The SA investigation agent may be configured to implement an investigation workflow to determine one or more entity investigation agents to investigate the at least one entity included in the alert evidence data, and implement the determined one or more entity investigation agents to investigate the at least one entity. The SA investigation agent may be configured to receive one or more respective intermediate verdicts from the one or more entity investigation agents. The one or more respective intermediate verdicts may indicate whether the at least one entity is malicious or benign. The SA investigation agent may be configured to determine a final verdict for the security alert based on the one or more respective intermediate verdicts.

In this aspect, additionally or alternatively, the one or more entity investigation agents may be first-level entity investigation agents, and the at least one entity may be a first-level entity. The SA investigation agent may be configured to instruct the first-level investigation agents to implement one or more second-level entity investigation agents to investigate at least one second-level entity related to the first-level entity.

In this aspect, additionally or alternatively, the SA investigation agent may be configured to retrieve the security alert from a queue of security alerts.

In this aspect, additionally or alternatively, the SA investigation agent may be configured to retrieve a plurality of like security alerts from the queue of security alerts and implement a concurrent parallel investigation of each of the plurality of like security alerts.

In this aspect, additionally or alternatively, user-defined adaptability criteria may be applied to the security alert to determine whether the security alert is malicious or benign.

In this aspect, additionally or alternatively, the one or more entity investigation agents may be configured to execute one or more primary tools, independent tools, and third party tools to investigate the at least one entity.

In this aspect, additionally or alternatively, the SA investigation agent may verify that each of the one or more entity investigation agents executed the primary tools during their respective investigations.

In this aspect, additionally or alternatively, when one or more entity investigation agents do not complete execution of the primary tools within a predetermined await time, the SA investigation agent may be configured to rerun the one or more entity investigation agents with the primary tools.

In this aspect, additionally or alternatively, the SA investigation agent may be implemented utilizing a large language model (LLM).

Another aspect provides a method for investigating a security alert with an automated artificial intelligence security operations center. The method may comprise, at a security operations center (SOC) analyst (SA) investigation agent, receiving a trigger to initiate an investigation for a security alert and retrieving alert evidence data. The alert evidence data may include at least one entity related to the security alert. The method may comprise implementing an investigation workflow to determine one or more entity investigation agents to investigate the at least one entity included in the alert evidence data and implementing the determined one or more entity investigation agents to investigate the at least one entity. The method may comprise receiving one or more respective intermediate verdicts from the one or more entity investigation agents. The one or more respective intermediate verdicts may indicate whether the at least one entity is malicious or benign. The method may comprise determining a final verdict for the security alert based on the one or more respective intermediate verdicts.

In this aspect, additionally or alternatively, the one or more entity investigation agents may be first-level entity investigation agents, the at least one entity may be a first-level entity, and the method may further comprise instructing, at the SA investigation agent, the first-level investigation agents to implement one or more second-level entity investigation agents to investigate at least one second-level entity related to the first-level entity.

In this aspect, additionally or alternatively, the method may further comprise retrieving the security alert from a queue of security alerts.

In this aspect, additionally or alternatively, the method may further comprise applying user-defined adaptability criteria to the security alert to determine whether the security alert is malicious or benign.

In this aspect, additionally or alternatively, the method may further comprise retrieving a plurality of like security alerts from the queue of security alerts and implementing a concurrent parallel investigation of each of the plurality of like security alerts.

In this aspect, additionally or alternatively, the method may further comprise executing, at the one or more entity investigation agents, one or more primary tools, independent tools, and third party tools to investigate the at least one entity.

In this aspect, additionally or alternatively, the method may further comprise verifying, at the SA investigation agent, that each of the one or more entity investigation agents executed the primary tools during their respective investigations.

In this aspect, additionally or alternatively, the method may further comprise, when one or more entity investigation agents do not complete execution of the primary tools within a predetermined await time, rerunning, at the SA investigation agent, the one or more entity investigation agents with the primary tools.

In this aspect, additionally or alternatively, the method may further comprise implementing the SA investigation agent as a large language model (LLM).

Another aspect provides a computing system for an adaptable automated artificial intelligence security operations center alert investigation. The computing system for the adaptable automated artificial intelligence security operations center alert investigation may comprise a computing device including processing circuitry configured to execute instructions using portions of associated memory to implement an automated artificial intelligence (AI) security operations center (SOC) investigation program. The automated AI SOC investigation program may include an SOC analyst (SA) investigation agent. The SA investigation agent may be configured to, in an inference phase, receive a trigger to initiate an investigation for a security alert and retrieve alert evidence data. The alert evidence data may include at least one entity related to the security alert. The SA investigation agent may be configured to implement an adaptability agent to evaluate the security alert based on user-defined adaptability criteria. The adaptability agent may include an adaptability tool that is configured to process the alert evidence data according to user-defined adaptability criteria to reach an adaptability verdict. If the adaptability verdict indicates the security alert is malicious or benign, then the SA investigation agent may be configured to refrain from implementing an investigation workflow and output a final verdict that indicates the security alert is malicious or benign. If the adaptability verdict is indeterminate, then the SA investigation agent may be configured to implement an investigation workflow to determine a plurality of entity investigation agents to investigate the at least one entity included in the alert evidence data. The SA investigation agent may be configured to implement the determined plurality of entity investigation agents to investigate the at least one entity and receive a respective intermediate verdict from each of the plurality of entity investigation agents. The intermediate verdicts may indicate whether the at least one entity is malicious or benign. The SA investigation agent may be configured to aggregate the intermediate verdicts and determine a final verdict for the security alert based on the aggregated intermediate verdicts

In this aspect, additionally or alternatively, the user-defined adaptability criteria may include a whitelist that specifies a plurality of whitelist rules. The adaptability agent may be implemented utilizing an LLM. The whitelist rules may be defined in natural language and input to the adaptability agent.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for an automated artificial intelligence security operations center alert investigation, comprising:
a computing device including processing circuitry configured to execute instructions using portions of associated memory to implement an automated artificial intelligence (AI) security operations center (SOC) investigation program, the automated AI SOC investigation program including an SOC analyst (SA) investigation agent, wherein the SA investigation agent is configured to:
in an inference phase:
receive a trigger to initiate an investigation for a security alert;
retrieve alert evidence data, the alert evidence data including at least one entity related to the security alert;
implement an investigation workflow to determine one or more entity investigation agents to investigate the at least one entity included in the alert evidence data;
implement the determined one or more entity investigation agents to investigate the at least one entity;
receive one or more respective intermediate verdicts from the one or more entity investigation agents, the one or more respective intermediate verdicts indicating whether the at least one entity is malicious or benign; and
determine a final verdict for the security alert based on the one or more respective intermediate verdicts.

2. The computing system of claim 1, wherein
the one or more entity investigation agents are first-level entity investigation agents and the at least one entity is a first-level entity, and
the SA investigation agent is configured to instruct the first-level investigation agents to implement one or more second-level entity investigation agents to investigate at least one second-level entity related to the first-level entity.

3. The computing system of claim 1, wherein
the SA investigation agent is configured to retrieve the security alert from a queue of security alerts.

4. The computing system of claim 3, wherein
the SA investigation agent is configured to retrieve a plurality of like security alerts from the queue of security alerts and implement a concurrent parallel investigation of each of the plurality of like security alerts.

5. The computing system of claim 1, wherein
user-defined adaptability criteria are applied to the security alert to determine whether the security alert is malicious or benign.

6. The computing system of claim 1, wherein
the one or more entity investigation agents are configured to execute one or more primary tools, independent tools, and third party tools to investigate the at least one entity.

7. The computing system of claim 6, wherein
the SA investigation agent verifies that each of the one or more entity investigation agents executed the primary tools during their respective investigations.

8. The computing system of claim 6, wherein
when one or more entity investigation agents do not complete execution of the primary tools within a predetermined await time, the SA investigation agent is configured to rerun the one or more entity investigation agents with the primary tools.

9. The computing system of claim 1, wherein
the SA investigation agent is implemented utilizing a large language model (LLM).

10. A method for investigating a security alert with an automated artificial intelligence security operations center, the method comprising:
at a security operations center (SOC) analyst (SA) investigation agent:
receiving a trigger to initiate an investigation for a security alert;
retrieving alert evidence data, the alert evidence data including at least one entity related to the security alert;
implementing an investigation workflow to determine one or more entity investigation agents to investigate the at least one entity included in the alert evidence data;
implementing the determined one or more entity investigation agents to investigate the at least one entity;
receiving one or more respective intermediate verdicts from the one or more entity investigation agents, the one or more respective intermediate verdicts indicating whether the at least one entity is malicious or benign; and
determining a final verdict for the security alert based on the one or more respective intermediate verdicts.

11. The method of claim 10, wherein
the one or more entity investigation agents are first-level entity investigation agents and the at least one entity is a first-level entity, and the method further comprises:
instructing, at the SA investigation agent, the first-level investigation agents to implement one or more second-level entity investigation agents to investigate at least one second-level entity related to the first-level entity.

12. The method of claim 10, the method further comprising:
retrieving the security alert from a queue of security alerts.

13. The method of claim 12, the method further comprising:
applying user-defined adaptability criteria to the security alert to determine whether the security alert is malicious or benign.

14. The method of claim 12, the method further comprising:
retrieving a plurality of like security alerts from the queue of security alerts; and
implementing a concurrent parallel investigation of each of the plurality of like security alerts.

15. The method of claim 10, the method further comprising:
executing, at the one or more entity investigation agents, one or more primary tools, independent tools, and third party tools to investigate the at least one entity.

16. The method of claim 15, the method further comprising:
verifying, at the SA investigation agent, that each of the one or more entity investigation agents executed the primary tools during their respective investigations.

17. The method of claim 15, the method further comprising:
when one or more entity investigation agents do not complete execution of the primary tools within a predetermined await time, rerunning, at the SA investigation agent, the one or more entity investigation agents with the primary tools.

18. The method of claim 10, the method further comprising:
implementing the SA investigation agent as a large language model (LLM).

19. A computing system for an adaptable automated artificial intelligence security operations center alert investigation, comprising:
a computing device including processing circuitry configured to execute instructions using portions of associated memory to implement an automated artificial intelligence (AI) security operations center (SOC) investigation program, the automated AI SOC investigation program including an SOC analyst (SA) investigation agent, wherein the SA investigation agent is configured to:
in an inference phase:
receive a trigger to initiate an investigation for a security alert;
retrieve alert evidence data, the alert evidence data including at least one entity related to the security alert; and
implement an adaptability agent to evaluate the security alert based on user-defined adaptability criteria, the adaptability agent including an adaptability tool that is configured to process the alert evidence data according to user-defined adaptability criteria to reach an adaptability verdict, wherein
if the adaptability verdict indicates the security alert is malicious or benign, then the SA investigation agent is configured to:
refrain from implementing an investigation workflow; and
output a final verdict that indicates the security alert is malicious or benign, and
if the adaptability verdict is indeterminate, then the SA investigation agent is configured to:
implement an investigation workflow to determine a plurality of entity investigation agents to investigate the at least one entity included in the alert evidence data;
implement the determined plurality of entity investigation agents to investigate the at least one entity;
receive a respective intermediate verdict from each of the plurality of entity investigation agents, the intermediate verdicts indicating whether the at least one entity is malicious or benign;
aggregate the intermediate verdicts; and
determine a final verdict for the security alert based on the aggregated intermediate verdicts.

20. The computing system of claim 19, wherein
the user-defined adaptability criteria includes a whitelist that specifies a plurality of whitelist rules,
the adaptability agent is implemented utilizing an LLM, and
the whitelist rules are defined in natural language and input to the adaptability agent.
